(19) United States
(12) Patent Application Publication
(10) Pub. No.: US 2026/0317501 A1
(43) Pub. Date: Oct. 15, 2026

(54) METHOD AND PLANT FOR PLASTICS PROCESSING

(71) Applicant: ARAplus GmbH, Wien (AT)

(72) Inventors: Mathias KULICH, Wien (AT); Jürgen SECKLEHNER, Wien (AT)

(73) Assignee: ARAplus GmbH, Wien (AT)

(21) Appl. No.: 19/484,450

(22) PCT Filed: May 14, 2024
(86) PCT No.: PCT/AT2024/060207

§ 371 Date: Nov. 14, 2025

(30) Foreign Application Priority Data
May 17, 2023 (AT) A50392/2023

(51) Int. Cl. C08J 11/06; B29B 17/02; B29B 17/04; B29K 23/00

(52) U.S. Cl. CPC C08J 11/06; B29B 17/02; B29B 17/0412; B29B 2017/0231; B29B 2017/0272; B29K 2023/00; C08J 2323/00

(57) ABSTRACT

A method, and a system for carrying out this method, for processing a target sorting fraction with a polyolefin content of at least 80 m%, in particular of at least 90 m%, from a waste fraction for further chemical and/or mechanical recycling of the target sorting fraction includes feeding and shredding or homogenizing a first mixed plastic fraction and, if necessary, additionally a second mixed plastic fraction to or by a shredding device. Furthermore, the method includes the metal separating of ferrous impurities and/or magnetizable impurities, the separation of impurities of a first heavy fraction and the fine separation of a second heavy fraction, wherein the system includes corresponding system components for carrying out the method.

The invention relates to a method for processing, in particular for predominantly mechanical but also partially chemical processing of a target sorting fraction with a polyolefin content of at least 80%, in particular at least 90%, from a waste fraction for further chemical and/or mechanical recycling of the target sorting fraction.

With the introduction of recycling quotas for plastic packaging, the need to treat waste fractions that could not previously be mechanically recycled and therefore had to be thermally recycled becomes clear. Various chemical recycling methods can be used for some of these fractions. In particular, tests with fractions with different levels of polyolefins have shown that resource- and energy-efficient processing of these waste fractions is only possible if they have a polyolefin content of more than 80 m% or, in particular, more than 80 m%, an impurity content of less than 7 m% and a moisture content of less than 20%, in particular less than 15%.

According to the current state of the art, only sorting fractions that are already processed in mechanical recycling fulfill these criteria. Sorting residues from mechanical recycling or mixed plastic fractions cannot comply with these limit values or those required for mechanical recycling, such as a sorting purity of more than 95%. As these fractions, i.e. sorting residues and mixed plastic fractions, are therefore mainly used in thermal recycling, these quantities are lost in the calculation for the highest possible recycling rate. It therefore makes sense from both an environmental and economic point of view to further process precisely these fractions, namely sorting residues and mixed plastic fractions, into a target sorting fraction and to feed this target sorting fraction into a subsequent chemical recycling process. Due to the high energy input and material losses that occur during chemical recycling and the associated costs, the preliminary products, i.e. sorting residues and mixed plastic fractions, with which a target sorting fraction can be processed for chemical recycling, are cheaper than the preliminary products for mechanical recycling. However, in order to meet the economic viability of an increased recycling rate, the processing of a target sorting fraction for chemical and/or mechanical recycling of plastics must be implemented as cost-effectively as possible.

Sorting and separation methods for processing waste fractions or plastic fractions are known from EP 2750812 B1 or WO 0067977A1. These known sorting and separation methods have the disadvantage that, on the one hand, specific preliminary products and mixing ratios of the preliminary products are necessary for carrying out the method and that, on the other hand, the target sorting fractions produced are already further processed or, with regard to chemical purity, have too unspecific a sorting for subsequent chemical and/or mechanical recycling.

The object of the present invention was to overcome the disadvantages of the prior art and to provide a method and a system for carrying out the method, by means of which method a target sorting fraction with a high proportion of polyolefins and a low proportion of impurities from sorting residues and mixed plastic fractions or other waste or plastic waste fractions can be processed as cost-effectively as possible in terms of chemical purity.

This object is solved by a method and a system for carrying out the method according to the claims.

The method according to the invention is used for processing, in particular for predominantly mechanical but also optionally partial chemical processing of a target sorting fraction with a polyolefin content of at least 80 m%, in particular of at least 90 m%, from a waste fraction for further chemical and/or mechanical recycling of the target sorting fraction, wherein the waste fraction comprises a first mixed plastic fraction from sorting of plastic waste from municipal and/or commercial waste collection systems, such as sorting residues from light packaging sorting, in particular of light packaging, or light packaging sorting, and a second mixed plastic fraction from the sorting of residual or commercial waste.

The first mixed plastic fraction may have a polyolefin content of 50 m% to 70 m%, a particle size of 20 mm to 600 mm, a metallic impurity content of up to 10 m% and a content of biogenic materials, minerals or other impurities, such as other plastics, of up to 40 m%.

The second mixed plastic fraction may have a polyolefin content of less than 20 m%, a particle size of up to 50 mm due to pre-shredding, a metallic impurity content of up to 5 m% and a content of biogenic materials, minerals or other impurities of up to 75 m%.

The method according to the invention comprises the following successive, but not necessarily directly successive, method steps:
feeding the first mixed plastic fraction and possibly, but not necessarily, the second mixed plastic fraction to a shredding device;
shredding and, if necessary, mixing the first mixed plastic fraction and the second mixed plastic fraction by means of the shredding device;
transporting the waste fraction by means of a third conveyor device and simultaneously metal separating of ferrous impurities and/or magnetizable impurities from the waste fraction, so that a non-metallic waste fraction is provided for the further method steps;

The method also comprises the following further successive, but not necessarily directly successive, method steps:
separating impurities from non-plastic impurities or of impurities which have a predominant proportion of substances with a density of more than 1 g/cm³, in particular more than 1.8 g/cm³, and with a particle size in the range from 3 mm to 8 mm, in particular from 3 mm to 6 mm, from the waste fraction by means of a separator device, wherein a first heavy fraction is separated and discharged during separating impurities and thus a good fraction is provided for the further method steps;
transporting the waste fraction or the now processed good fraction to a pre-silo or to a pre-container or a buffer container and buffering the waste fraction in the pre-silo;
feeding the waste fraction buffered in the pre-silo or the now processed good fraction to a hydrocyclone;
fine separation of plastic granulate with adhering or fixed non-plastic impurities and of plastics with a density of more than 1 g/cm³ from the waste fraction or from the good fraction by means of the hydrocyclone by means of a wet method using a liquid, wherein a second heavy fraction is thus separated and discharged;
discharging the target sorting fraction from the hydrocyclone.

By using a wet method in the hydrocyclone, the fractions that can be processed in it are also washed, which advantageously reduces the formation of odors during further storage or processing of the second heavy fraction and the target sorting fraction. As an alternative to a hydrocyclone, a decanter may also be used for this method step. In any case, the hydrocyclone or decanter can be used to carry out a friction wash with a force acting on the good fraction in the range of 750 g to 2000 g. In order to increase the longevity of the hydrocyclone or decanter or to extend the interval between necessary maintenance intervals, the good fraction can be arranged or configured upstream of the hydrocyclone or decanter in a mash container for further separation of heavy impurities.

The sequence of the sorting or separation method steps of the method according to the invention does not necessarily have to be adhered to. However, the stated sequence of the sorting or separation method steps of the method according to the invention proves to be particularly advantageous with regard to the quality of the target sorting fraction that can be processed as a result, so that the requirements for subsequent chemical and/or mechanical recycling of the target sorting fraction are met. In particular, it is advantageous if the separation of impurities, for example by means of drum dryers, is upstream of the fine separation by means of the hydrocyclone, as this allows a higher throughput of the waste fraction to be achieved compared to the reverse sequence.

An advantage of the method according to the invention is that in particular the first mixed plastic fraction and the second mixed plastic fraction, as described above, can be mechanically processed in a simple manner in such a way that on the one hand the impurity fractions, comprising a metallic impurity fraction, the first heavy fraction and the second heavy fraction can be separated and removed from the waste fraction and that on the other hand the required composition of the target sorting fraction is achieved at the end of the method. Due to the corresponding sequence of the method steps of the method according to the invention, the impurity fractions and the target sorting fraction can be separated particularly economically, so that the waste fraction that was previously only recyclable by thermal recovery has now been further processed in a value-adding manner, since at least the target sorting fraction can be made available for chemical and/or mechanical recycling. This is achieved in particular by sequencing the individual method steps in accordance with the invention, since the required quality of the target sorting fraction can thus be achieved in a resource-saving and energy-efficient manner, namely a polyolefin content of at least 80 m% or, in particular, at least 90 m%, and an impurity content of less than 7 m%.

Furthermore, it may be useful if the first mixed plastic fraction is continuously fed to the shredding device in the form of compressed and/or agglomerated bales by means of a first conveyor device.

Municipal plastic waste is usually collected and pre-sorted to form the first mixed plastic fraction, possibly as a sorting residue of the municipal plastic waste. The pre-sorting can be carried out at a different location than the further processing to the desired target sorting fraction. Since the first mixed plastic fraction must therefore be easy and economical to transport, it is usually produced in the form of bales, which can advantageously be processed directly using the method according to the invention. Since the first mixed plastic fraction may have the predominant proportion of the waste fraction, as this first mixed plastic fraction may have a higher proportion of polyolefins relative to the second mixed plastic fraction, it is advantageous to feed it to the shredding device in compressed bales, since in this way the highest possible throughput rate for processing the target sorting fraction can be achieved with comparably small or simple dimensioning of the first conveyor device compared to loosely occurring fractions.

Furthermore, it may be provided that the second mixed plastic fraction is continuously fed to the shredding device in loose form by means of a second conveyor device. This second conveyor device may be formed by a conveyor belt, for example. This makes it easy to achieve improved dosing of the second mixed plastic fraction, so that the end product of the method, namely the target sorting fraction, can be modified as easily as possible in terms of its quality. In this context, it should be noted that the second mixed plastic fraction is not necessarily fed in or that the feed can be temporarily suspended.

In addition, it may be provided that a proportion of the second mixed plastic fraction in the range from 5 m% to 20 m% is set for the waste fraction during shredding and, if necessary, mixing of the first mixed plastic fraction and the second mixed plastic fraction by means of the shredding device by adjusting the conveying speed of the second conveyor device. Since the proportion of polyolefins in the first mixed plastic fraction can at best be estimated, the range of the proportion of polyolefins in the target sorting fraction is subsequently limited by defining the range for the proportion of the second mixed plastic fraction. This also makes it easy to maintain the quality of the target sorting fraction within the range required for chemical recycling. This reduces or completely avoids the possible exclusion of the target sorting fraction, as the proportion of polyolefins will be present in a specified range anyway.

Another advantageous embodiment is one according to which it may be provided that the waste fraction is shredded in the shredding device to a particle size of at most 25 mm, wherein the shredding device is configured such that impurities are also shredded to a particle size of at most 25 mm. This is a simple way of improving the effectiveness of the separation of impurities in the method steps following shredding and mixing, particularly in metal separation. This in turn leads to a higher yield of target sorting fraction per waste fraction introduced, which improves the economic efficiency of the method.

According to an advancement, it is conceivable that the metal separation of ferrous impurities is carried out by means of an overband magnet device, whereby the method further comprises an eddy current separation of magnetizable impurities in an eddy current separator immediately downstream of the third conveyor device. This makes it possible for ferrous impurities and non-ferrous but magnetizable impurities to be separated into separate fractions. This means that these fractions can be subjected to further material recycling, which in turn improves the overall cost-effectiveness of the method.

Furthermore, it may be useful if the first heavy fraction is separated during the separating impurities by means of the separator device comprising a plurality of drum dryers arranged parallel and/or in series with respect to the transport of the waste fraction. The first heavy fraction, which is cleaned or separated in the drums, is suitable as a fuel in cement systems due to its high proportion of biogenic materials and their fine, fibrous consistency. The mineral content may be incorporated into a clinker and subsequently processed into cement and thus recycled. This in turn improves the overall cost-effectiveness of the method, as a further impurity fraction can be separated in such a way that it can be reused.

In addition, it may be provided that the liquid used in the hydrocyclone comprises predominantly water, wherein the liquid is circulated during the continuous application of the method and continuously purified or recycled by filtration, by adaptation of the pH value and/or by heavy metal separation by means of a processing device. The advantage of this is that the use of resources for the method of separating the first target sorting fraction is minimized, which in turn improves economic efficiency and also protects the environment.

Furthermore, it may be provided that the additives comprising salts, ethanol, oils, acids, alkalis, detergents and/or defoamers are added to the liquid used in the hydrocyclone, wherein the additives are mainly added to adapt the pH value and to adjust the density of the liquid. This means that the reprocessing of the liquid in the hydrocyclone can be maintained for longer and that, synergically, the cleaning or washing of the fractions that can be processed in the hydrocyclone is improved. This makes the method more resource-efficient and economical. Adjusting the density may be relevant for the selectivity and enables a reaction to new types of plastics. Other parameters that are relevant for the selectivity are the speed, the acceleration and the grain size of the material.

The invention also relates to a system for carrying out the method described above for processing a target sorting fraction with a polyolefin content of at least 80 m%, in particular of at least 90 m%, from a waste fraction for further chemical and/or mechanical recycling of the target sorting fraction, wherein the waste fraction comprises at least a first mixed plastic fraction from sorting of municipal and/or commercial plastic waste, in particular of lightweight packaging or lightweight packaging sorting, and optionally also a second mixed plastic fraction from sorting of residual or commercial waste.

The system comprises the following system components:
a shredding device for shredding and optionally mixing the waste fraction;
a first conveyor device for feeding the first mixed plastic fraction to the shredding device in the form of compressed and/or agglomerated bales;
a second conveyor device for feeding the second mixed plastic fraction to the shredding device in loose form;
a third conveyor device for conveying the waste fraction and an overband magnet device for metal separating of metallic impurities from the waste fraction;
an eddy current separator for non-ferrous metal separation of metallic impurities from the waste fraction;
a separator device comprising at least one drum dryer or alternatively, but not necessarily, a plurality of drum dryers arranged parallel and/or in series with respect to one another in relation to the transport of the waste fraction;
a pre-silo for buffering the waste fraction; and
a hydrocyclone for fine separation.

The system is characterized in that the waste fraction formed from the first mixed plastic fraction and possibly also from the second mixed plastic fraction can pass sequentially through the shredding device, the third conveyor device with the overband magnet device, the eddy current separator, the separating device, the pre-silo and the hydrocyclone,
wherein ferrous metals can be separated and discharged by means of the overband magnet device and non-ferrous metals can be separated and discharged by means of the eddy current separator, so that a non-metallic waste fraction can be made available to the downstream system components,
wherein at least one screen basket of the drum dryer or the screen baskets of the drum dryers of the separator device have perforations in the range from 3 mm to 8 mm, in particular from 3 mm to 6 mm, for separating non-plastic impurities or of impurities which have a predominant proportion of substances with a density of more than 1 g/cm³, in particular of more than 1.8 g/cm³, and with a particle size in the range from 3 mm to 8 mm from the non-metallic waste fraction, wherein a first heavy fraction can be separated or discharged by means of the separator device and a good fraction can be made available for the downstream system components,
wherein the good fraction can be stored or buffered in the pre-silo, so that a continuous supply of the good fraction to the hydrocyclone can be provided,
wherein by means of the hydrocyclone by fine separation, in particular by friction washing with a force acting on the good fraction in the range between 750 g and 2000 g, plastic granulate with non-plastic impurities adhering or fixed thereto and plastics with a density of more than 1 g/cm³ can be separated and discharged from the good fraction as a second heavy fraction and the target sorting fraction can be discharged.

An advantage of the system according to the invention for carrying out the method for processing a target sorting fraction is that, in particular, the first mixed plastic fraction and the second mixed plastic fraction, as described above, can be mechanically processed in a simple manner in such a way that on the one hand the impurity fractions, comprising a ferrous impurity fraction, a magnetizable impurity fraction, the first heavy fraction and the second heavy fraction can be separated and discharged from the waste fraction and that on the other hand the required composition of the target sorting fraction can be discharged or made available after the waste fraction has passed through the system. Due to the corresponding juxtaposition of the system components of the system according to the invention for carrying out the method for processing the target sorting fraction, the impurity fractions and the target sorting fraction can be separated particularly economically, so that the waste fraction, which was previously only recyclable by thermal recycling, can now be further processed in a value-adding, resource-saving and economical manner, since at least the target sorting fraction can be made available for chemical and/or mechanical recycling. In particular, it is advantageous if the separation of impurities by means of the drum dryer or the drum dryers is upstream of the fine separation by means of the hydrocyclone, as this allows a higher throughput of the waste fraction to be achieved compared to the reverse sequence. In addition, the entry of substances that can be dissolved in water into the water circuit of the hydrocyclone or decanter is reduced. This leads to an improved water quality, which means less effort in water treatment and therefore energy savings and reduced wear on the hydrocyclone or decanter. This is achieved in particular by lining-up the individual system components in accordance with the invention, since the required quality of the target sorting fraction can thus be achieved in a resource-saving and energy-efficient manner, namely a polyolefin content of at least 80 m% or, in particular, at least 90 m%, and an impurity content of less than 7 m%.

According to a particular embodiment, it is conceivable for the waste fraction to be reduced to a particle size of no more than 25 mm by means of the shredding device. This simply improves the effectiveness of the separation of impurities in the system components or method steps following the shredding and mixing, especially in metal separation. This in turn leads to a higher yield of the target sorting fraction relative to the amount of waste fraction fed in, which improves the economic efficiency of the system and thus also of the method.

According to an advantageous advancement, it may be provided that the system further comprises a processing device for continuous processing of a liquid used in the hydrocyclone by filtration, adaptation of the pH value of the liquid and heavy metal separation. The advantage of this is that the use of resources for operating the system or for carrying out the method for separating the first target sorting fraction is minimized, which in turn improves the economic efficiency of the system and also protects the environment.

For a better understanding of the invention, it is explained in more detail with the aid of the following figures.

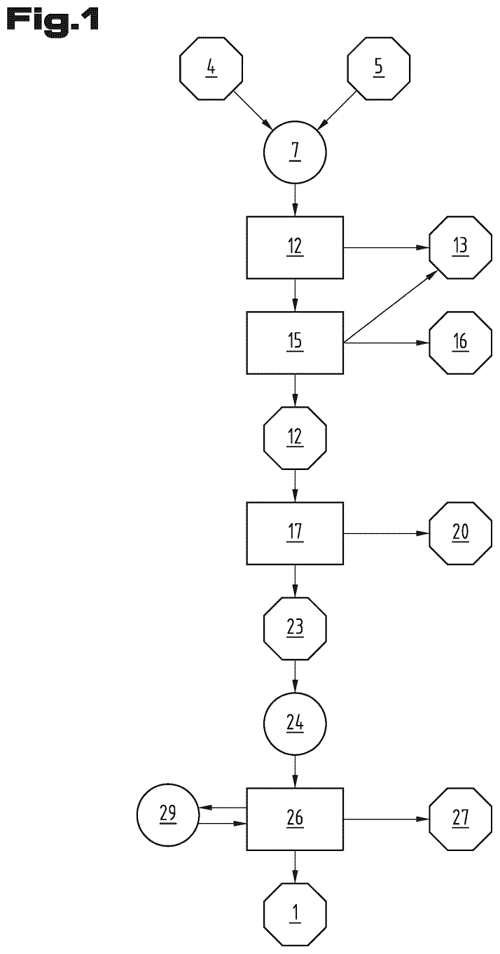

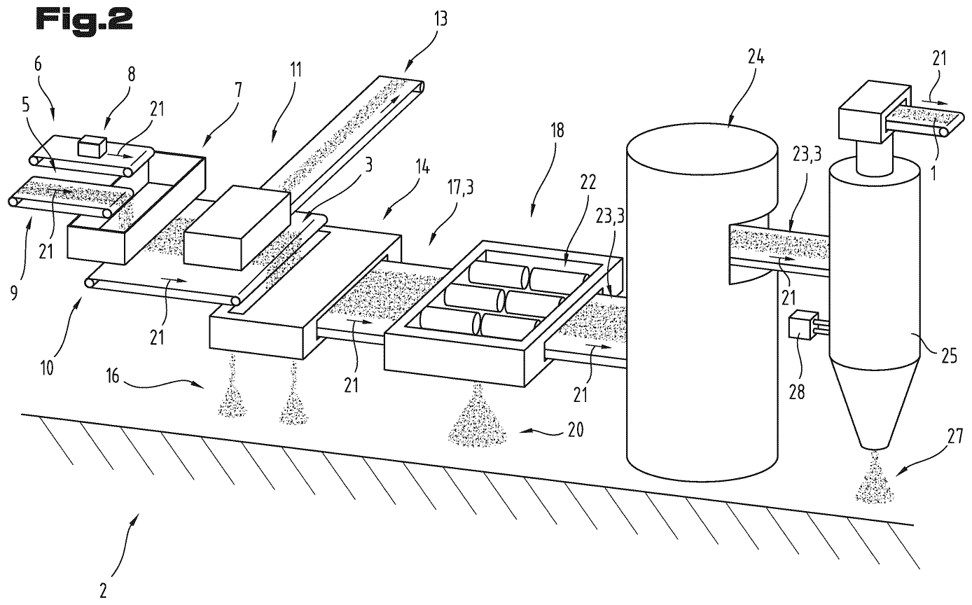

The figures show a simplified, schematic representation as follows:
FIG. 1 a schematic representation of a possible sequence of the method according to the invention;
FIG. 2 a schematic representation of a possible embodiment of a system for carrying out the method according to the invention.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

FIG. 1 shows a schematic representation of a possible sequence of the method according to the invention for mechanical processing of a target sorting fraction 1. FIG. 2 also shows a schematic representation of a possible embodiment of a system 2 for carrying out the method according to the invention, with the same reference symbols or designations being used for identical parts as in FIG. 1.

For a better understanding of the possible sequence of the method according to the invention, individual sorting or separation method steps are marked with squares in FIG. 1, individual system components of the system 2 are marked with circles and individual fractions are marked with hexagons.

As can be seen from FIG. 1 in combination with FIG. 2, the method is provided for mechanical processing of the target sorting fraction 1, which target sorting fraction 1 may have a polyolefin content of at least 80 m%, in particular of at least 90 m%. The target sorting fraction 1 can thus be used economically for a chemical and/or mechanical recycling method. The target sorting fraction 1 can be processed from a waste fraction by sorting or separation method steps of the method according to the invention from a waste fraction 3, wherein the waste fraction 3 is a first mixed plastic fraction 4 from sorting of municipal plastic waste or from a sorting fraction of municipal plastic waste and a second mixed plastic fraction 5 from sorting residual or commercial waste or from a sorting fraction of residual or commercial waste.

In a first method step of the method according to the invention, the first mixed plastic fraction 4 may be fed by means of a first conveyor device 6 to a shredding device 7, wherein the first mixed plastic fraction 4 may be fed to the shredding device 7 in the form of compressed and/or agglomerated bales. Furthermore, the second mixed plastic fraction 5 may be fed to the shredding device 7 in loose form by means of a second conveyor device 9. The shredding device 7 may be configured to shred the first mixed plastic fraction 4 and the second mixed plastic fraction 5 and to mix them in order to provide the waste fraction 3 for the further method steps.

It may be provided that a proportion of the second mixed plastic fraction 5 is adjusted by adjusting a conveying speed of the second conveyor device 9 or alternatively by adjusting a further conveying speed of the first conveyor device 6, so that the proportion of the second mixed plastic fraction 5 of the waste fraction 3 can be set in the range from 5 m% to 20 m%.

Furthermore, the shredding device 7 may be configured to provide a particle size of the waste fraction 3 of no more than 25 mm by shredding the first mixed plastic fraction 4 and the second mixed plastic fraction 5, wherein also impurities as for example metallic impurities can be shredded to a particle of no more than 25 mm.

In a further method step of the method according to the invention, the now shredded and mixed waste fraction 3 can be discharged or conveyed by means of a third conveyor device 10 from the shredding device 7, wherein the system 2 comprises furthermore an overband magnet device 11 operatively connected to or acting on the waste fraction 3 that can be conveyed by means of the third conveyor device 10 for metal separating 12 of metallic impurities from the waste fraction 3. By means of the overband magnet device 11, in particular ferrous impurities 13 can be separated and discharged from the waste fraction 3.

Furthermore, the system 2 may comprise an eddy current separator 14 for eddy current separation 15 of magnetizable impurities 16, so that non-ferrous metals and remaining ferrous metals can be separated and discharged from the waste fraction 3. This means that the waste fraction 3 may be provided as a non-metallic waste fraction 17 in the system 2 for the subsequent method steps.

In a further method step, the waste fraction 3 or the now non-metallic waste fraction 17 can be fed to a separator device 18 of the system 2 for separating non-plastic impurities or impurities with a density of more than 1 g/cm³, in particular more than 1.8 g/cm³, and a particle size in the range of 3 mm to 8 mm from the waste fraction 3 or the now non-metallic waste fraction 17 by separating 19 impurities and discharge them as a first heavy fraction 20. The separator device 18 may comprise a plurality of drum dryers 22 which are arranged parallel and/or in series in relation to the conveying direction 21 of the waste fraction 3 or the now non-metallic waste fraction 17, wherein screen baskets of the drum dryers 22 may have perforations in the range from 3 mm to 8 mm for separating 19 impurities of the first heavy fraction 20. As a particularly advantageous embodiment, a drum dryer 22 may be configured with a screen basket that has a first portion with perforations of 3 mm and a second portion with perforations of 6 mm. By separating 19 impurities by means of the separator device 18, the first heavy fraction 20 can be separated and discharged, so that the waste fraction 3 can be discharged and provided, by means of the separator device 18, as a good fraction 23 for further processing by means of the system 2 by the following method steps.

In a further subsequent method step, the waste fraction 3 or the good fraction 23 now processed by the preceding sorting and separation method steps may be conveyed to a pre-silo 24 in order to buffer or temporarily store the good fraction 23 for subsequent method steps.

In a further subsequent method step, the waste fraction 3 or the now processed good fraction 23 temporarily stored in the pre-silo 24 can be fed to a hydrocyclone 25 for fine separation 26 of plastics with adhering or fixed non-plastic impurities and of plastics with a density of more than 1 g/cm³ from the waste fraction 3 or the now processed good fraction 23 for separating and discharging a second heavy fraction 27. After separation and discharge of the second heavy fraction 27 from the waste fraction 3 or from the good fraction 25 fed to the hydrocyclone 23, the remaining target sorting fraction 1 with a polyolefin content of at least 80 m%, in particular at least 90 m%, can be discharged. It may be provided that the fine separation 26 is carried out using the hydrocyclone 25 in a wet method with a liquid. It may further be provided that the liquid predominantly comprises water, wherein the liquid is circulated during the continuous application of the method and continuously purified by filtration, by adaptation of the pH value and/or by heavy metal separation by means of a processing device 28 and recycled or subjected to wastewater treatment 29.

Finally, as a matter of form, it should be noted that for ease of understanding of the structure, elements are partially not depicted to scale and/or are enlarged and/or are reduced in size.

### LIST OF REFERENCE SIGNS

1 target sorting fraction
2 system
3 waste fraction
4 first mixed plastic fraction
5 second mixed plastic fraction
6 first conveyor system
7 shredding device
8 bale
9 second conveyor system
10 third conveyor system
11 overband magnet device
12 metal separation
13 ferrous impurities
14 eddy current separator
15 eddy current separation
16 magnetizable impurities
17 non-metallic waste fraction
18 separator device
19 separation of impurities
20 first heavy fraction
21 conveying direction
22 drum dryer
23 good fraction
24 pre-silo
25 hydrocyclone
26 fine separation
27 second heavy fraction
28 processing device
29 wastewater treatment

1. A method for processing a target sorting fraction (1) with a polyolefin content of at least 80 m%, in particular of at least 90 m%, from a waste fraction (3), wherein the waste fraction (3) can be composed of a first mixed plastic fraction (4) from sorting of municipal plastic waste and possibly, but not necessarily, of a second mixed plastic fraction (5) from sorting of residual or commercial waste, wherein the method comprises the following successive, but not necessarily immediately successive, method steps:
feeding the waste fraction (3) to a shredding device (7),
wherein the first mixed plastic fraction (4) is continuously fed to the shredding device (7) by means of a first conveyor device (6) in the form of compressed and/or agglomerated bales (8), and
wherein the second mixed plastic fraction (5) is continuously fed to the shredding device (7) by means of a second conveyor device (9) in loose form;
shredding the waste fraction (3) by means of the shredding device (7);
conveying the waste fraction (3) by means of a third conveyor device (10) and simultaneously metal separating (12) of ferrous impurities (13) and/or magnetizable impurities (16) from the waste fraction (3);
separating (19) impurities of non-plastic impurities which have a predominant proportion of substances with a density of more than 1 g/cm³, in particular of more than 1.8 g/cm³, and with a particle size in the range from 3 mm to 8 mm, in particular in the range from 3 mm to 6 mm, from the waste fraction (3) by means of a separator device (18), wherein a first heavy fraction (20) is discharged during separating (19) impurities;
conveying the waste fraction (3) to a pre-silo (24) and buffering the waste fraction (3) in the pre-silo (24);
feeding the waste fraction (3) buffered in the pre-silo (24) to a hydrocyclone (25) or a decanter;
fine separation (26) of plastic pellets with adhering or fixed non-plastic impurities and of plastics with a density of more than 1 g/cm³ from the waste fraction (3) by means of the hydrocyclone (25) or a decanter by a wet method using a liquid;
discharging the target sorting fraction (1) from the hydrocyclone (25) or the decanter wherein
for the waste fraction (3) during shredding and mixing the first mixed plastic fraction (4) and the second mixed plastic fraction (5) by means of the shredding device (7), a proportion of the second mixed plastic fraction (5) is set in the range from 5 m% to 20 m% by adjusting a conveying speed of the second conveyor device (9).

2-4. (canceled)

5. The method according to claim 1, wherein the waste fraction (3) is shredded in the shredding device (7) to a particle size of at most 25 mm, wherein the shredding device (7) is configured such that impurities are also shredded to a particle size of at most 25 mm.

6. The method according to claim 1, wherein the metal separating (12) of ferrous impurities (13) is carried out by means of an overband magnet device (11), wherein the method further comprises an eddy current separation (15) of magnetizable impurities (16) in an eddy current separator (14) immediately downstream of the third conveyor device (10).

7. The method according to claim 1, wherein the first heavy fraction (20) is separated during separating (19) impurities by means of the separator device (18) comprising a plurality of drum dryers (22) arranged parallel and/or in series with respect to the conveying direction (21) of the waste fraction (3).

8. The method according to claim 1, wherein the liquid used in the hydrocyclone (25) or in the decanter predominantly comprises water, wherein the liquid is circulated during the continuous application of the method and continuously purified by filtration, by adaptation of the pH value and/or by heavy metal separation by means of a processing device (28) and reprocessed or subjected to wastewater treatment (29).

9. The method according to claim 8, wherein the additives comprising salts, ethanol, oils, acids, alkalis, detergents and/or defoamers are added to the liquid used in the hydrocyclone (25) or in the decanter, wherein the additives are added primarily to adapt the pH value and to adjust the density.

10. A system (2) for carrying out the method according to claim 1 for processing a target sorting fraction (1) with a polyolefin content of at least 80 m%, in particular of at least 90 m%, from a waste fraction (3) for further chemical and/or mechanical recycling of the target sorting fraction (1), wherein the waste fraction (3) comprises at least a first mixed plastic fraction (4) from sorting of municipal plastic waste and optionally also a second mixed plastic fraction (5) from sorting of residual or commercial waste, the system (2) comprising the following system components:
a shredding device (7) for shredding the waste fraction (3);
a first conveyor device (6) for feeding the first mixed plastic fraction (4) to the shredding device (7) in the form of compressed and/or agglomerated bales (8);
a second conveyor device (9) for feeding the second mixed plastic fraction (5) to the shredding device (7) in loose form;
a third conveyor device (10) for conveying the waste fraction (3) and an overband magnet device (11) for metal separating (12) of ferrous impurities (13) from the waste fraction (3);
an eddy current separator (14) for separating magnetizable impurities (16) from the waste fraction (3);
a separator device (18) comprising at least one drum dryer (22);
a pre-silo (24) for buffering the waste fraction (3); and
a hydrocyclone (25) or a decanter for fine separation (26);
wherein
the shredding device (7), the third conveyor device (10) with the overband magnet device (11), the eddy current separator (14), the separator device (18), the pre-silo (24) and the hydrocyclone (25) or the decanter can be passed through sequentially by the waste fraction (3),
wherein ferrous impurities (13) can be separated and discharged by means of the overband magnet device (11) and magnetizable impurities (16) can be separated and discharged by means of the eddy current separator (14), so that a non-metallic waste fraction (17) can be made available to the downstream system components,
wherein at least one screen basket of the drum dryer (22) of the separator device (18) has perforations in the range from 3 mm to 8 mm, in particular from 3 mm to 6 mm, for separating (19) impurities of non-plastic impurities or of impurities which have a predominant proportion of substances with a density of more than 1 g/cm³, in particular of more than −1.8 g/cm³, and with a particle size in the range from 3 mm to 8 mm from the non-metallic waste fraction (17), wherein a first heavy fraction (20) can be separated or discharged by means of the separator device (18) and a good fraction

(23) can be made available for the downstream system components,
wherein the good fraction (23) can be stored or buffered in the pre-silo (24), so that a continuous supply of the good fraction (23) to the hydrocyclone (25) or the decanter can be provided,
wherein by means of the hydrocyclone (25) or the decanter, plastics with adhering or fixed non-plastic impurities are removed by fine separation (26), and plastics with a density of more than 1 g/cm³ can be separated and discharged from the good fraction (23) as a second heavy fraction (27) and the target sorting fraction (1) can be discharged.

11. The system (2) according to claim 10, wherein the waste fraction (3) can be shredded by means of the shredding device (7) to a particle size of at most 25 mm.

12. The system (2) according to claim 10, further comprising a processing device (28) for continuous processing of a liquid used in the hydrocyclone (25) or in the decanter by filtration, adaptation of the pH value of the liquid and heavy metal separation.
